(19) United States
(12) Patent Application Publication
(10) Pub. No.: US 2018/0180251 A1
(43) Pub. Date: Jun. 28, 2018

(54) LASER PROJECTION DEVICE AND LASER SOURCE THEREOF

(71) Applicants: HISENSE CO., LTD., QINGDAO (CN); HISENSE USA CORPORATION, SUWANEE, GA (US); HISENSE INTERNATIONAL CO., LTD., QINGDAO (CN)

(72) Inventor: YOULIANG TIAN, QINGDAO (CN)

(21) Appl. No.: 15/449,883

(22) Filed: Mar. 3, 2017

(30) Foreign Application Priority Data
Dec. 27, 2016 (CN) 201611223900.8
Dec. 27, 2016 (CN) 201611226507.4

(51) Int. Cl. F21V 7/06; F21V 7/10; G03B 21/14

(52) U.S. Cl. CPC F21V 7/06; F21Y 2113/10; G03B 21/14; F21V 7/10

(57) ABSTRACT

Provided are a laser source and a laser projection device. The laser source includes: a light focusing cup, provided with a concaved reflecting surface on inner side and an optical through-hole on bottom; a light transmissive processing assembly, disposed on inner side of light focusing cup and opposite to optical through-hole; a first laser source, configured to emit a first light beam and disposed on outer side of light focusing cup, the first light beam being incident on light transmissive processing assembly through optical through-hole; and a second laser source, configured to emit a second light beam and disposed on inner side of light focusing cup, the second light beam being incident on light transmissive processing assembly after being reflected by the reflecting surface. The laser source and laser projection device can reduce volume of entire laser source, facilitating miniaturization of laser projection devices.

### CROSS-REFERENCE TO RELATED APPLICATIONS

This application claims priority to Chinese Patent Application No. 201611223900.8, filed on Dec. 27, 2016, entitled “LASER PROJECTION DEVICE AND LASER SOURCE THEREOF”, and priority to Chinese Patent Application No. 201611226507.4, filed on Dec. 27, 2016, entitled “LASER PROJECTION DEVICE AND LASER SOURCE THEREOF”, which are hereby incorporated by reference in their entireties.

### TECHNICAL FIELD

This application relates to the field of laser projection, particularly to a laser projection device and a laser source thereof.

### BACKGROUND

Laser is a light source that has high luminance and strong directivity and that creates a monochromatic coherent light beam. Thanks to its various advantages, laser is becoming a light source in applications in the technical field of projection display.

However, when applied in the technical field of projection display, laser sources in related art have decentralized structures with relatively large volume.

### SUMMARY

On a first aspect, this application provides a laser source, including:

a light focusing cup, provided with a concaved reflecting surface on an inner side thereof and an optical through-hole on a bottom thereof;

a light transmissive processing assembly, disposed on the inner side of the light focusing cup and opposite to the optical through-hole;

a first laser source, configured to emit a first light beam and disposed on an outer side of the light focusing cup, the first light beam being incident on the light transmissive processing assembly through the optical through-hole; and

a second laser source, configured to emit a second light beam and disposed on the inner side of the light focusing cup, the second light beam being incident on the light transmissive processing assembly after being reflected by the reflecting surface of the light focusing cup.

On a second aspect, this application provides a laser source, including:

a light focusing cup, provided with a concaved reflecting surface on an inner side thereof;

a light transmissive processing assembly, disposed on the inner side of the light focusing cup; and

a laser source, disposed on the inner side of the light focusing cup and configured to emit an excitation light beam, where the excitation light beam is reflected onto the light transmissive processing assembly by the reflecting surface of the light focusing cup.

On a third aspect, this application provides a laser projection device, including: a laser source, an optical assembly, a lens, and a projection screen; the laser source including: a light focusing cup, provided with a concaved reflecting surface on an inner side thereof and an optical through-hole on a bottom thereof; where,

a light transmissive processing assembly is disposed on the inner side of the light focusing cup and opposite to the optical through-hole;

a first laser source is configured to emit a first light beam and disposed on an outer side of the light focusing cup, the first light beam being incident on the light transmissive processing assembly through the optical through-hole;

a second laser source is configured to emit a second light beam and disposed on the inner side of the light focusing cup, the second light beam being incident on the light transmissive processing assembly after being reflected by the reflecting surface of the light focusing cup; and

the laser source outputs three-primary-color light to the optical assembly, the optical assembly adjusts amount of the three-primary-color light, and the adjusted three-primary-color light is outputted to the lens and projected through the lens onto the projection screen to form a projected image.

### BRIEF DESCRIPTION OF DRAWINGS

FIG. 1A is a schematic structural diagram illustrating a laser source provided in some embodiments of the present application;

FIG. 1B is a schematic structural diagram illustrating a laser source provided in some embodiments of the present application;

FIG. 2A is a schematic structural diagram illustrating a laser source provided in some embodiments of the present application;

FIG. 2B is a schematic structural diagram illustrating a laser source in related art;

FIG. 2C is a schematic structural diagram illustrating a laser source provided in some embodiments of the present application;

FIG. 2D is a schematic structural diagram illustrating a transmissive fluorescent wheel of the laser source depicted in FIG. 2C;

FIG. 3A is a schematic structural diagram illustrating a laser source provided in some embodiments of the present application;

FIG. 3B is a schematic structural diagram illustrating a laser source provided in some embodiments of the present application;

FIG. 3C is a top view of an arrangement structure for a laser source provided in some embodiments of the present application;

FIG. 3D is a schematic structural diagram illustrating a laser source provided in some embodiments of the present application;

FIG. 3E is a schematic structural diagram illustrating a laser source provided in some embodiments of the present application;

FIG. 4 is a schematic structural diagram illustrating a light focusing cup provided in some embodiments of the present application;

FIG. 5A is a schematic view illustrating a mode of movement for a diffusing sheet provided in some embodiments of the present application;

FIG. 5B is a schematic view illustrating a mode of movement for a diffusing sheet provided in some embodiments of the present application;

FIG. 5C is a schematic view illustrating a mode of movement for a diffusing sheet provided in some embodiments of the present application;

FIG. 6A is a schematic partitioning plan for a diffusing sheet provided in some embodiments of the present application;

FIG. 6B is a schematic partitioning plan for a diffusing sheet provided in some embodiments of the present application; and

FIG. 7 is a schematic framework of a laser projection device provided in some embodiments of the present application.

### DETAILED DESCRIPTION

The following descriptions will detail embodiments that demonstrate features and advantages of the present application. It should be understood that this application can have various changes with respect to different embodiments without departing from the scope of this application, and the descriptions and drawings herein are in essence for descriptive purposes, rather than for limiting this application.

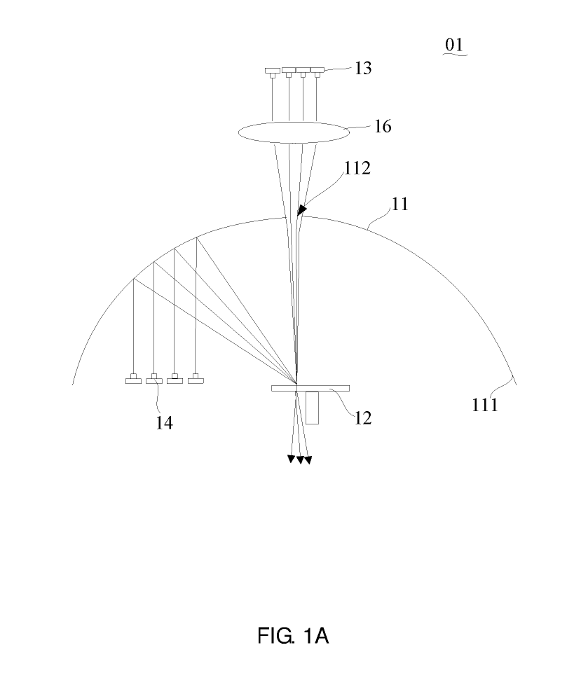

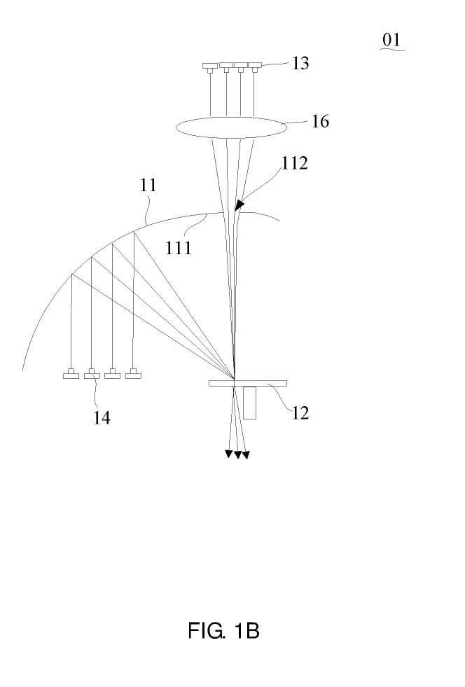

Some embodiments of this application provide a laser source 01 that is used for providing illuminating light beams to a laser projection device. Referring to FIG. 1A, the laser source 01 includes a light focusing cup 11, a light transmissive processing assembly 12, a first laser source 13, and a second laser source 14. The first laser source 13 is located on the outer side of the light focusing cup 11, while the light transmissive processing assembly 12 and second laser source 14 are located on the inner side of the light focusing cup 11.

The light focusing cup 11 is configured to reflect light beams, and is formed generally into a bowl shape structure, with a concaved reflecting surface on its inner side. That is, the concaved surface of the light focusing cup 11 is a reflecting surface 111. An incident point on the light transmissive processing assembly 12 may be provided at the focal point of the reflecting surface of the light focusing cup 11, where the incident point on the light transmissive processing assembly 12 means a location on the light transmissive processing assembly for accepting incident light. As a possible implementation, the concaved surface of the light focusing cup 11 is formed into a paraboloid. That is, the reflecting surface 111 is a paraboloid. Being a paraboloid, the reflecting surface 111 can ensure that a second light beam emitted from the second laser source 14 is incident on the reflecting surface 111 as a parallel light beam and then can be focused at the focal point after being reflected by the reflecting surface 111. In this implementation, the incident point on the light transmissive processing assembly 12 may be provided at the focal point of the paraboloid. While allowing light to pass through, the light transmissive processing assembly also can perform light beam diffusion, phase change or fluorescence excitation.

It can be understood that the reflecting surface 111 may also be a sphere. The second light beam emitted from the second laser source 14 falls on the sphere, i.e. the reflecting surface 111, and is reflected by the reflecting surface 111 and focused at the focal point of the sphere. The first light beam also falls on the focal point of the sphere through transmission. In this implementation, the incident point on the light transmissive processing assembly 12 may be provided at the focal point of the sphere.

An optical through-hole 112 is disposed on the bottom of the light focusing cup 11. As a possible implementation, the light focusing cup 11 is provided with an opening on the top, and the optical through-hole 112 on the bottom. Additionally, the optical through-hole 112 is located at the bottom center of the light focusing cup 11. The size of the optical through-hole 112 is the same as that of a light spot projected by the first laser source 13 on the light focusing cup 11, so as to ensure that the entire laser beam from the first laser source 13 can pass through the optical through-hole 112.

The light transmissive processing assembly 12 is disposed on the inner side of the light focusing cup 11, i.e. the side of the light focusing cup 11 on which the reflecting surface 111 is disposed, and the light transmissive processing assembly 12 is disposed opposite to the optical through-hole 112. As an implementation, the light transmissive processing assembly 12 is disposed at the focal point of the reflecting surface 111 of the light focusing cup 11.

The first laser source 13 is disposed on the outer side of the light focusing cup 11 for emitting a first light beam. The first light beam passes through the optical through-hole 112 and falls on the light transmissive processing assembly 12.

As a possible implementation, the first laser source 13 is disposed opposite to the optical through-hole 112, so that the first light beam can pass through the optical through-hole 112 and directly fall on the light transmissive processing assembly 12. The first laser source 13, the optical through-hole 112, and the focal point of the reflecting surface 111 of the light focusing cup 11 (i.e. the incident point on the light transmissive processing assembly) can be joined by a common straight line. It can be understood that the first laser source 13 can also reflect the first light beam onto the optical through-hole 112 via a reflecting mirror, a total reflection prism or the like.

It can be understood that the first laser source 13 may be a laser device array formed by multiple laser devices with an array configuration.

As a possible implementation, the laser source 01 is further provided with a focusing lens 16 along the light emitting direction of the first laser source 13. The focusing lens 16 is located between the light focusing cup 11 and the first laser source 13 for confining the emergent light from the first laser source 13 so that the emergent ray can pass through the optical through-hole 112. As an implementation, the incident point on the light transmissive processing assembly 12 may be located at the focal point of the focusing lens 16. The incident point on the light transmissive processing assembly 12 is the location where the light beam enters the light transmissive processing assembly 12. Thus, the first light beam from the first laser source 13 converges at the incident point on the light transmissive processing assembly 12 via the focusing lens 16.

It can be understood that the focusing lens 16 may be a focusing lens set consisting of multiple lenses, which will not be limited herein, as long as the first light beam is allowed to pass through the optical through-hole 112 and fall on the incident point on the light transmissive processing assembly 12.

The second laser source 14 is disposed on the inner side of the light focusing cup 11, and is configured to emit a second light beam. The second light beam is reflected by the reflecting surface 111 of the light focusing cup 11 and incident on the light transmissive processing assembly 12. As a possible implementation, the second laser source 14 may be disposed in parallel with the light transmissive processing assembly 12.

It can be understood that the second laser source 14 may be a set of laser arrays consisting of multiple laser devices.

As an variation based on the above described applications, the light focusing cup can be further formed into a simpler shape so as to further reduce the volume of the laser source framework, when only a single second laser source 14, i.e. a single set of laser device array, is disposed on the inner side of the reflecting surface 111 of the light focusing cup 11. For instance, in the framework depicted in FIG. 1A, the part of the light focusing cup that corresponds to the unused portion of the reflecting surface may be omitted. That is, the paraboloid may be disposed only in part, such as a half, with the improved structure being illustrated in FIG. 1B. In the laser source framework depicted in FIG. 1B, the light transmissive processing assembly 12 may be disposed by referring to that of FIG. 1A.

In some embodiments of this application, the laser source framework efficiently exploits the inner space of the light focusing cup, leading to a compact laser source structure that facilitates microminiaturization of laser projection devices.

In related art, a laser-only source in the laser projection device suffers from considerable speckle effect. Since the speckle effect can reduce the image quality of a projected image, the laser projection device using the laser source will need to include in the laser source an optical circuit for removing speckles. When a laser source includes multiple sets of laser devices in different colors, a speckle removing component, e.g. a diffusion film or a random phase sheet, need to be disposed for each laser device, so that the rotating diffusion film or random phase sheet diverges the laser beam, contributing to speckle removing. Then, respective diverged laser beams are combined through a light combining element, e.g. a dichroscope, into a single output light beam, forming the illuminating light beam. However, such optical circuit design leads to a relatively large number of optical circuit elements, resulting in a decentralized laser source structure with large volume.

Hence, as depicted in FIG. 1A, an implementation is provided in some embodiments of this application, in which the light transmissive processing assembly 12 is a transmissive diffusing sheet. The diffusing sheet is provided with diffusing particles on a surface thereof facing the reflecting surface 111 of the light focusing cup 11, and can transmit light beams and diffuse light. The first light beam, which is emitted by the first laser source 13 disposed on the outer side of the light focusing cup 11, passes through the optical through-hole 112, falls on the diffusing sheet, and passes through the diffusing sheet. The second light beam, which is emitted by the second laser source 14 disposed on the inner side of the light focusing cup 11, is reflected by the reflecting surface of the light focusing cup 11, falls on the diffusing sheet, and passes through the diffusing sheet.

The first laser source 13 and the second laser source 14 produce light beams of different colors. For instance, one of the laser sources may be a blue laser, while another laser source may be a red laser, so that both the blue laser and red laser can pass through the diffusing sheet for undergoing diffusion-based speckle removing.

The diffusing sheet may be a random phase sheet or a diffusion film.

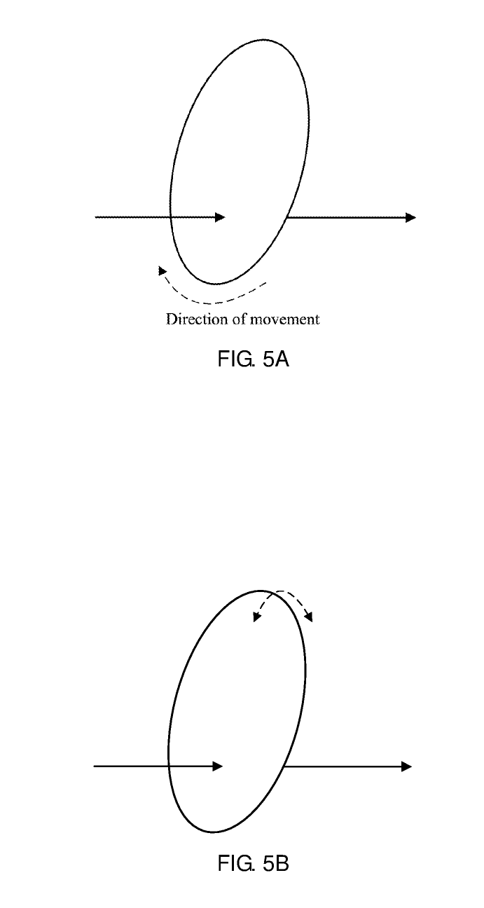

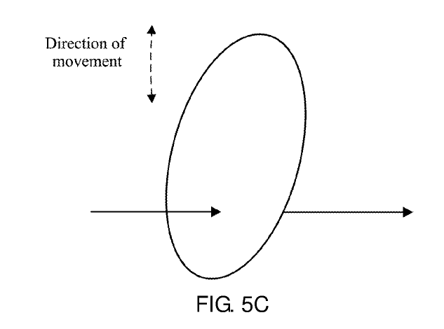

The diffusing sheet may be actuated by a motor to rotate periodically, e.g. to rotate in a circle direction as depicted in FIG. 5A. Alternatively, the diffusing sheet may be actuated by a driving component to swing, e.g. front-and-back or left-and-right in the plane containing the diffusing sheet, with the X-axis or Y-axis of the plane being the axis of rotation, as depicted in FIG. 5B. Alternatively, the diffusing sheet may be actuated by a driving component to vibrate up-and-down, as depicted in FIG. 5C. It should be noted that the above descriptions are merely examples of, rather than limitations on, the mode of movement of the diffusing sheet.

When the diffusing sheet rotates in the manner illustrated in FIG. 5A, the first light beam from the first laser source 13 and the second light beam from the second laser source 14 sequentially fall on different diffusing regions on the diffusing sheet following a lighting time sequence, where they undergo speckle removing via the rotating diffusing sheet.

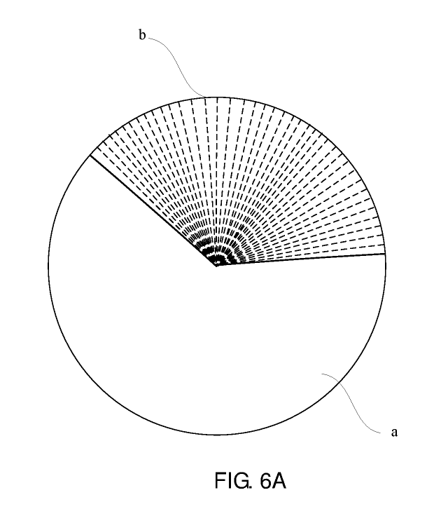

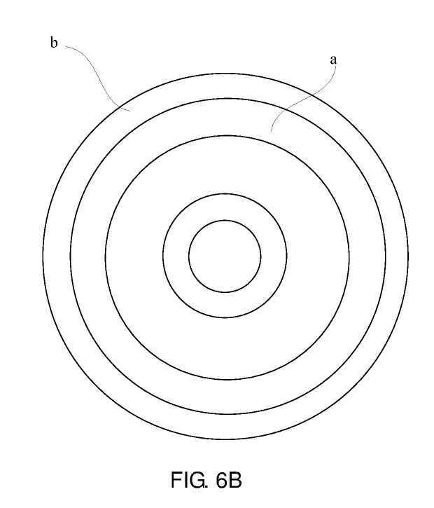

Since human eyes have different sensitivity to speckles for lasers of different colors, a first diffusing region a and a second diffusing region b may be disposed on the diffusing sheet, respectively, as depicted in FIG. 6A, according to different colors of the laser beams. As the diffusing sheet rotates, different diffusing regions a and b are respectively exposed to laser beams of different colors. When the diffusing sheet rotates in the manner illustrated in FIG. 5A, the first light beam from the first laser source 13 and the second light beam from the second laser source 14 sequentially fall on the first diffusing region a and the second diffusing region b following a lighting time sequence.

Illustratively, the first diffusing region a may be used for transmission of blue laser, and the second diffusing region b may be used for transmission of red laser. The granularity and divergency angle for the diffusing particles are different for the first diffusing region and the second diffusing region. For instance, the divergency angle may be larger for the diffusing particles in the second diffusing region than those in the first diffusing region, so that the diffusing sheet removes more speckles for the red laser than for the blue laser, thereby balancing the speckle effects of lasers of these two colors in human vision.

It should be noted that the above wording “first” and “second” are merely used for differentiating different diffusing regions, and do not constitute any limitation on the actual sequence or order.

In some embodiments of this application, the reflective light focusing cup can converge laser beams from a dual color laser source on the surface of a single rotating diffusing sheet that can diffuse the transmitted laser beams in order to remove speckles, thereby making more efficient use of the speckle removing component. Meanwhile, the light source framework effectively exploits the inner space of the light focusing cup, which has a compact structure that facilitates microminiaturization of laser projection devices.

As a possible implementation, if the above described laser source is employed as a projection light source, the laser source may include at least three primary colors. Therefore, based on the above described laser source framework, the above described laser source may be further provided with a third light source in order to output the three primary colors, where the third light source may be a laser device array or LED light source, or a fluorescence source.

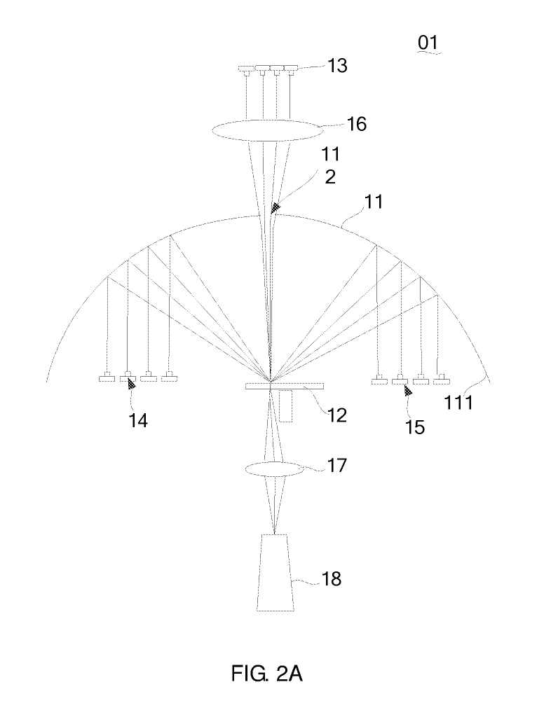

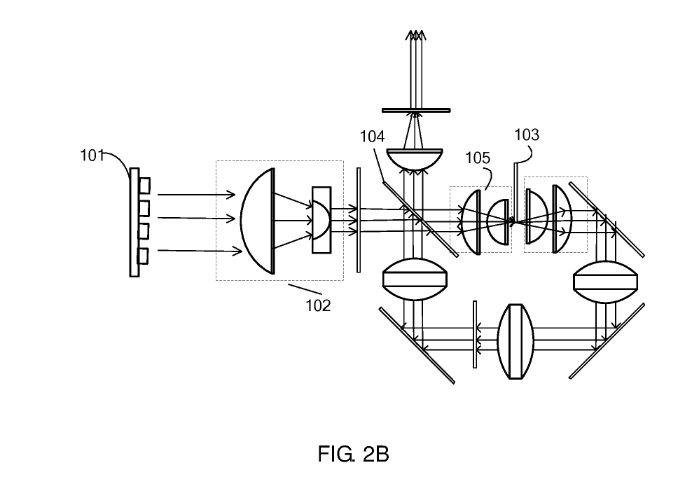

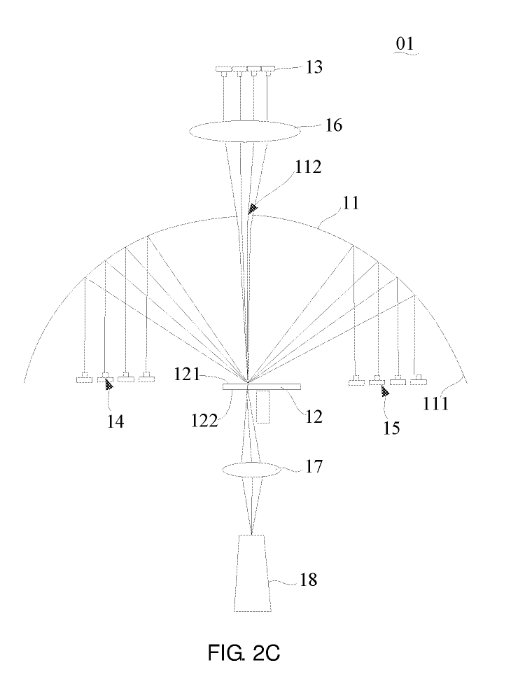

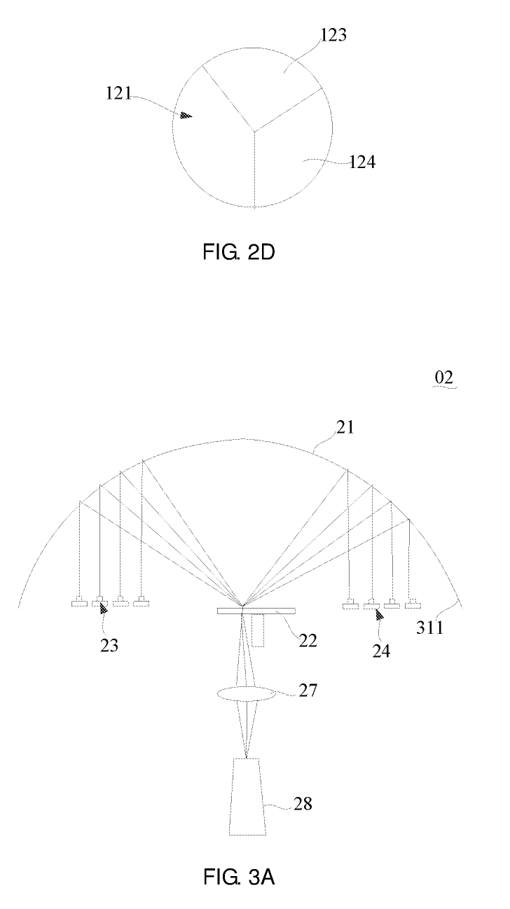

The following descriptions will be given by taking a laser device array as the third light source as an example. As depicted in FIG. 2A, on the basis of the light source framework depicted in FIG. 1A, a third laser source 15 is included and configured to emit a third light beam. The third light beam has a color different from that of the first light beam and the second light beam, for instance, a green laser.

It should be noted that the first light beam, the second light beam and the third light beam are not limit to the order of colors that are described in some embodiments of this application as long as the three colors can constitute three primary colors, and the arrangement of the three laser sources is not limited to the manner of their colors deciding their locations.

In some embodiments of this application, a high reflection layer may be disposed on the reflecting surface 111 of the light focusing cup 11, which can totally reflect the light beam incident on the reflecting surface 111, so as to increase optical energy utilization of the laser source 01.

As depicted in FIG. 2A, the third laser source 15 is also disposed on the inner side of the light focusing cup 11 and in parallel with the diffusing sheet. In some embodiments, the second laser source 14 and the third laser source 15 are disposed along the peripheral of the diffusing sheet. It can be understood that the second laser source 14 and the laser source 15 may be symmetrically distributed on two sides of the diffusing sheet, or asymmetrically distributed along the peripheral thereof, or located in a plane in parallel with, but not necessarily contained within, the plane where the diffusing sheet is located. In some embodiments, the third laser source 15 is disposed in a horizontal plane where the second laser source 14 and the diffusing sheet are located, as shown in FIG. 2A. It can be understood that the plane where the second laser source 14, the diffusing sheet and the third laser source 15 are located may not be horizontal, which depends on the angle or direction in which the light focusing cup 11 is placed.

Both the second light beam and the third light beam can be reflected by the reflecting surface 111 of the light focusing cup 11 and incident on the diffusing sheet, while the first light beam is incident and transmitted onto the diffusing sheet through the optical through-hole 112, so that three primary colors can take turns to be transmitted and outputted from the other side of the diffusing sheet, forming an illuminating light beam.

In some embodiments of this application, the first laser source 13, the second laser source 14 and the third laser source 15 may all be a laser device array. The concaved surface of the light focusing cup 11 is a paraboloid. The incident point on the diffusing sheet may be provided at the focal point of the paraboloid. The laser device array emits a parallel light beam. That is, the second light beam and the third light beam are both parallel light beams that are parallel to the central axis of the paraboloid. Therefore, when the second light beam and the third light beam fall in parallel on the reflecting surface 111 of the light focusing cup 11, both the second light beam and the third light beam can converge at the focal point of the paraboloid after being reflected by the reflecting surface 111. Since the focal point of the paraboloid is located at the incident point on the diffusing sheet, the second light beam and third light beam reflected by the light focusing cup 11 can converge with the first light beam passing through the light focusing cup 11 at the incident point on the diffusing sheet, thereby utilizing the diffusing sheet to remove speckles. The diffusing sheet may move in different modes as those depicted in FIG. 5A, 5B or 5C, so as to enhance the effect of speckle removing.

Referring to FIG. 6A, the diffusing sheet may also be partitioned into different diffusing regions. A diffusing region which the green laser passes through may have a divergency angle identical to a divergency angle of a diffusing region which the blue laser passes through, or identical to a divergency angle of a diffusing region which the red laser passes through, or different from both.

Some embodiments of this application provide a laser source 01 in which a collimating lens and a converging lens 17 are further disposed along the direction in which the illuminating light beam propagates. The collimating lens collimates the illuminating light beam. The converging lens 17 converges and focuses the illuminating light beam. After passing through the diffusing sheet, the illuminating light beam will be in a divergent state and need to be collimated by the collimating lens and converged by the converging lens 17.

It can be understood that the collimating lens may also be a collimating lens set, which will not be limited herein. Similarly, the converging lens 17 may be a converging lens set consisting of multiple lenses, which will not be limited herein, as long as the illuminating light beam can be converged.

In some embodiments of this application, the laser source 01 is provided with a light uniforming member 18 along the direction in which the illuminating light beam propagates. An incident point on the light uniforming member 18 is provided at the focal point of the converging lens 17, and the incident point on the light uniforming member 18 is the central point of an end surface of the light uniforming member 18, the end surface being on an end closer to the diffusing sheet. The light uniforming member 18 is used for uniforming the illuminating light beam. The illuminating light beam is converged at the incident point on the light uniforming member 18 through the converging lens 17, and enters into the light uniforming member 18, where the light beam is uniformized by the light uniforming member 18. The light uniforming member 18 may be an optical wand. By means of being converged through the collimating lens and the converging lens 17 disposed on the rear side of the diffusing sheet and entering into the light uniforming member 18, a uniform illuminating light beam is provided.

In the laser source provided herein, a set of light sources are disposed on the outer side of the light focusing cup, while two additional sets of light sources, as well as a diffusing sheet, are disposed on the inner side of the light focusing cup. With the light focusing cup, laser beams from the first laser source, the second laser source and the third laser source are converged on the surface of the diffusing sheet. In addition, following a lighting time sequence, different laser beams pass through, and are diffused by, the diffusing sheet, accomplishing speckle removing purposes. In addition, laser beams of different colors take turn to pass through the diffusing sheet following a lighting time sequence, which exploits the diffusing sheet for speckle removing in a more efficient way. The second laser source, the third laser source and the diffusing sheet are disposed inside the light focusing cup, which can make efficient use of the inner space in the light focusing cup, compact the laser source framework, reduce the volume of the laser source framework, and facilitate microminiaturization of laser projection devices.

In related art, in laser sources of laser projection devices, it is typically a blue laser device that illuminates a fluorescent wheel coated with fluorescent powder to excite the fluorescent powder on the fluorescent wheel and form a fluorescence beam. The fluorescence beam may be a light beam including different colors or a single color. For the purpose of increasing intensity of the illuminating light beam, the fluorescent wheel is typically designed with a fluorescent powder layer that, when subject to excitation, generates a fluorescence beam of a certain color.

As depicted in FIG. 2B, the excitation light from the laser device passes through a beam-shrinking lens set 102 to suffer from light spot beam-shrinking, then passes through a dichroscope 104, and enters into a collimating lens set 105 in the front of a reflective fluorescent wheel 103. After being focused, the focused light spot falls on the front of the fluorescent wheel 103, exciting the fluorescent powder to produce fluorescence. The fluorescence is reflected by a reflecting surface on the wheel body, passes through the collimating lens set 105, reaches the dichroscope 104, and is then reflected.

The fluorescent wheel 103 is provided with a transmissive region. When the excitation light from the blue laser device passes through the fluorescent wheel 103, blue primary color light emerges out of the rear side of the fluorescent wheel 103, passes through a collimating lens set 105 on the rear side, then through a relay lens set consisting of a number of reflecting mirrors and lenses, and eventually returns to the dichroscope 104. After being transmitted through the dichroscope 104, the light emerges, together with the fluorescence, along the direction in which the fluorescence is reflected, both of which are combined into a white illuminating light beam.

Thus, the laser source framework needs to be provided with multiple converging lens sets for converging the laser beam and the fluorescence beam, as well as multiple reflecting mirror sets or lens sets for adjusting optical paths of multiple light beams. In order to accomplish beam shrinking and beam forming, a light shrinking lens with a large size is required, and a certain optical path distance need to be reserved in the optical circuit, especially when multiple sets of laser device light sources arranged in vertical or parallel are used, leading to less compact laser source structure, as well as large volume of the laser source framework.

An implementation is provided in some embodiments of this application, in which the light transmissive processing assembly 12 is a transmissive fluorescent wheel. Referring to FIGS. 2C and 2D, the transmissive fluorescent wheel is partitioned into a fluorescent region 123 where fluorescent powder is provided, and a transmissive region 124. The surface of one side of the fluorescent region where fluorescent powder is provided is referred to as the front side 121, while the surface of the other side is referred to as the rear side 122. It can be understood that fluorescent region 123 may be provided with fluorescent powder of a single color or two colors. The fluorescent region 123 may be partitioned according to the different colors of the fluorescent powder.

The laser source 01 includes a light focusing cup 11, a transmissive fluorescent wheel 12, a first laser source 13, and a second laser source 14. The first laser source 13 is located on the outer side of the light focusing cup 11, while the transmissive fluorescent wheel 12 and second laser source 14 are located on the inner side of the light focusing cup 11. The light focusing cup 11 is configured to reflect light beams, with a concaved reflecting surface on its inner side. That is, the concaved surface of the light focusing cup 11 is a reflecting surface 111. An incident point on the transmissive fluorescent wheel 12 may be provided at the focal point of the reflecting surface of the light focusing cup 11, where the incident point on the transmissive fluorescent wheel 12 means a location on the transmissive fluorescent wheel 12 for accepting incident light.

The first light beam and the second light beam fall on the transmissive fluorescent wheel, and the fluorescent powder produces a fluorescence beam when excited by at least one of the first laser source and the second laser source. At least one of the first light beam and the second light beam is transmitted through the transmissive region. The light beam transmitted through the transmissive region and the fluorescence beam transmitted through the transmissive fluorescent wheel form an illuminating light beam. As a possible implementation, the first laser source is an excitation light source, the second laser source is a primary color light source, and the first light beam falls on the fluorescent powder of the transmissive fluorescent wheel to excite the same to produce the fluorescence beam. Alternatively, the first laser source is a primary color light source, the second laser source is an excitation light source, and the second light beam falls on the reflecting surface of the light focusing cup, and is reflected onto the transmissive fluorescent wheel, exciting the fluorescent powder of the transmissive fluorescent wheel to produce the fluorescence beam. Alternatively, the first laser source and the second laser source are both excitation light sources, and the first light beam and the second light beam excite the fluorescent powder of the transmissive fluorescent wheel simultaneously to produce the fluorescence beam.

It can be understood that the above described first laser source 13 may be, in addition to a laser device array consisting of multiple laser devices, an LED light source, multiple laser device arrays, an LED array or the like.

As a possible implementation, the above described laser source 01 may further include a third laser source 15. The third laser source 15 is configured to emit a third light beam, and is disposed in parallel with the transmissive fluorescent wheel. That is, the second laser source 14 and the third laser source 15 are disposed along the peripheral of the transmissive fluorescent wheel. It can be understood that the second laser source 14 and the third laser source 15 may be symmetrically distributed on two sides of the transmissive fluorescent wheel, or asymmetrically distributed along the peripheral of the transmissive fluorescent wheel according to different light intensity of the second laser source 14 and the third laser source 15.

The third light beam is reflected by the reflecting surface 111 of the light focusing cup 11 and incident on the fluorescent region 123 of the transmissive fluorescent wheel, and passes through the transmissive fluorescent wheel, forming an illuminating light beam. The surface of one side of the transmissive fluorescent wheel 12 where the fluorescent powder is provided is the front side 121 thereof, while the surface of the other side thereof is referred to as the rear side 122 of the transmissive fluorescent wheel 12.

It can be understood that the second laser source 14 may be a laser device array formed by multiple laser devices with an array configuration, or an LED array formed by arranging multiple LED light sources. In addition, the second laser source 14 may also be multiple laser device arrays or LED arrays. The third laser source 15 may be a laser device array formed by multiple laser devices with an array configuration, or an LED array formed by arranging multiple LED light sources. In addition, the third laser source 15 may also be multiple laser device arrays or LED arrays. Similarly, multiple sets of second laser sources 14 and multiple sets of third laser sources 15 may be symmetrically distributed around the transmissive fluorescent wheel, or asymmetrically distributed on two sides of the transmissive fluorescent wheel according to the light intensity distribution of the multiple sets of second laser source 14 and the multiple sets of third laser sources 15.

When the first laser source 13, the second laser source 14 and the third laser source 15 are all laser devices, the luminance and converging degree of the illuminating light beam produced by the laser source 01 can be increased because laser beams from laser devices are more energy-intensive and focused. For instance, in case the concaved surface of the light focusing cup 11 is a paraboloid and an incident point on the transmissive fluorescent wheel is provided at the focal point of the paraboloid, the laser device array emits a parallel light beam, and thus the second light beam and the third light beam are both parallel light beams that are parallel to the central axis of the paraboloid. Therefore, when the second light beam and the third light beam fall in parallel on the reflecting surface 111 of the light focusing cup 11, the second light beam and the third light beam will converge at the focal point of the paraboloid after being reflected by the reflecting surface 111. Since no other converging lens set is required to converge the second light beam and the third light beam at the same point, the structure of the laser source 01 can be simplified, and the volume of the laser source 01 can be reduced.

In some embodiments of this application, a high reflection layer may be disposed on the reflecting surface 111 of the light focusing cup 11. The high reflection layer can totally reflect incident light beams incident on the reflecting surface 111, so as to increase optical energy utilization of the laser source 01.

In some embodiments of this application, the laser source 01 may further be provided with a collimating lens and a converging lens 17 along the direction in which the illuminating light beam propagates. The collimating lens collimates the illuminating light beam. The converging lens 17 converges and focuses the illuminating light beam. Since the illuminating light beam transmitted through the transmissive fluorescent wheel approximates Lambertian body distribution, the light beam can be collimated through the collimating lens, and be converged through the converging lens 17.

It can be understood that the collimating lens may also be a collimating lens set, which will not be limited herein. Similarly, the converging lens 17 may be a converging lens set consisting of multiple lenses, which will not be limited herein, as long as the illuminating light beam can be converged.

In some embodiments of this application, the laser source 01 may further be provided with a light uniforming member 18 along the direction in which the illuminating light beam propagates. An incident point on the light uniforming member 18 is provided at the focal point of the converging lens 17, and the incident point on the light uniforming member 18 is the central point of an end surface which is on an end of the light uniforming member 18 and is closer to the transmissive fluorescent wheel. The light uniforming member 18 is used for uniforming the illuminating light beam. The illuminating light beam is converged at the incident point on the light uniforming member 18 through the converging lens 17, and enters into the light uniforming member 18, where the light beam is uniformized by the light uniforming member 18. The light uniforming member 18 may be an optical wand. By means of being converged through the collimating lens and the converging lens 17 disposed on the rear side 122 of the transmissive fluorescent wheel and entering into the light uniforming member 18, a uniform illuminating light beam is provided.

In the above described laser source 01, the light focusing cup 11 can converge laser beams from the first laser source 13, the second laser source 14 and the third laser source 15 on the surface of the transmissive fluorescent wheel. The second laser source 14, the third laser source 15 and the transmissive fluorescent wheel are disposed inside the light focusing cup 11, effectively exploiting the inner space of the light focusing cup 11. In addition, light beams from multiple light source sets are converged together by the light focusing cup 11, and can be combined with the fluorescence beam through the transmissive fluorescent wheel, thereby reducing the number of light combining elements employed in the optical circuit, and simplifying the structure of the laser source 01. As a result, the aforementioned laser source 01 is compactly configured, with reduced framework volume, which facilitates microminiaturization of laser projection devices.

At least one of the first laser source 13, the second laser source 14 and the third laser source 15 serves as an excitation light source that excites the fluorescent powder to produce a fluorescence beam that has at least one of three primary colors.

If the first laser source is the excitation light source, the first light beam will fall on, and excite, the fluorescent powder of the transmissive fluorescent wheel to produce the fluorescence beam. The first laser source 13 may be a blue laser device, an ultraviolet (UV) laser device or a blue LED lamp. In an instance where the first laser source 13 is a blue laser device, the fluorescent region of the transmissive fluorescent wheel may be provided with green fluorescent powder, so that the first laser source 13 excites the green fluorescent powder to emit green fluorescence beam. When the first laser source 13 serves as the excitation light source, it can be ensured that the first light beam is normal incident on the incident point on the transmissive fluorescent wheel with a relatively low requirement for precision, thereby ensuring efficiency of the excitation. In this implementation, the second laser source 14 and the third laser source 15 may be a primary color light source. The primary color light source is used for transmitting light through the transmissive fluorescent wheel, so as to be combined with the fluorescence beam into the illuminating light beam. At least one of the second laser source 14 and the third laser source 15 may be a red laser device. The transmissive region of the transmissive fluorescent wheel may be provided with a red light transmissive region and a blue light transmissive region. The blue laser beam from the first laser source 13 may pass through the blue light transmissive region. When the transmissive fluorescent wheel is rotated to the transmissive region, the red laser beam of the second light beam and third light beam may pass through the red light transmissive region, so that the red laser beam and the blue laser beam may pass through the red light transmissive region and the blue light transmissive region respectively, reaching the rear side 122 of the transmissive fluorescent wheel after transmission.

Hence, the first laser source 13, the second laser source 14 and the third laser source 15 are lighted according to a time sequence, and the transmissive fluorescent wheel is rotated to the fluorescent region and transmissive region in sequence. Thus, green fluorescence, blue laser and red laser emerges in turns, forming three-primary-color light. Then, the three-primary-color light is combined into a white illuminating light beam. It can be understood that at least one of the second laser source 14 and the third laser source 15 may be a red laser device, with the other being a blue laser device. Alternatively, the second laser source 14 and the third laser source 15 may be both red laser devices.

It can be understood that the fluorescent region of the transmissive fluorescent wheel may further be provided with yellow fluorescent powder and green fluorescent powder. In this implementation, the first laser source 13 may be a blue laser device, and the first light beam irradiates on the fluorescent powder. The blue excitation light beam excites the yellow fluorescent powder and the green fluorescent powder to produce a yellow fluorescence beam and a green fluorescence beam. The yellow fluorescence beam may pass through a red optical filter to obtain a red fluorescence beam. Thus, the fluorescence beam includes light beams of two primary colors. The second laser source 14 and the third laser source 15 may both be blue laser devices, or may be a blue laser device and a red laser device.

When the second laser source 14 and the third laser source 15 are both blue laser devices, the second light beam and the third light beam are both blue laser beams. The transmissive region of the transmissive fluorescent wheel may be provided with a blue light transmissive region. Thus, the yellow fluorescence beam, the green fluorescence beam and the blue laser beam form four-primary-color light beams, which are combined into a white illuminating light beam.

When one of the second laser source 14 and the third laser source 15 is a blue laser device, with the other being a red laser device, one of the second light beam and the third light beam is a blue laser beam, with the other being a red laser beam. Now, the transmissive region of the transmissive fluorescent wheel may be provided with a blue light transmissive region and a red light transmissive region. Thus, the yellow fluorescence beam, the green fluorescence beam, the blue laser beam and the red laser beam form four-primary-color light beams, which are combined into a white illuminating light beam.

It can be understood that the fluorescent region of the transmissive fluorescent wheel may further be provided with fluorescent powder of other colors, e.g. red fluorescent powder, green fluorescent powder and the like. Since the fluorescent powder of two or more different colors is provided, the fluorescence beam can include multiple colors as well.

In some embodiments of this application, there may be at least one type of fluorescence that has the same color as that of the first laser source 13, the second laser source 14 and the third laser source 15, and such a fluorescence beam may be mixed with a light source light beam to achieve light mixed effect. The light source light beam and the fluorescence beam that have the same color need to be outputted simultaneously, so that when the light source light beam is combined with the fluorescence beam into an illuminating light beam, the light can be mixed. Light mixed effect can expand the scope of the color gamut, increase brightness, correct color coordinates for such color, and reduce speckle effect of the laser.

In some embodiments of this application, at least one of the second laser source 14 and the third laser source 15 serves as an excitation light source. The excitation light source emits an excitation light beam. The excitation light beam falls on the reflecting surface 111 of the light focusing cup 11, and is reflected onto the transmissive fluorescent wheel, and excites the fluorescent powder of the transmissive fluorescent wheel to produce a fluorescence beam.

When the second laser source 14 or the third laser source 15 serves as the excitation light source, the first laser source 13 may be a primary color light source. The second light beam or the third light beam is incident on the reflecting surface 111 of the light focusing cup 11, and reflected by the reflecting surface 111 of the light focusing cup 11 onto the focal point of the paraboloid, i.e. the incident point on the transmissive fluorescent wheel. Now, the first laser source 13, the second laser source 14 and the third laser source 15 may take turns to output light according to a time sequence.

When the first laser source 13, the second laser source 14 and the third laser source 15 are all laser devices, one laser device of the second laser source 14 and the third laser source 15, which serves as the excitation light source, may be a blue laser device, while the other laser device, which does not serve as the excitation light source, may be a red laser device or a green laser device. In this implementation, the first laser source 13 is a green laser device or a red laser device. The transmissive fluorescent wheel may be provided with a red light transmissive region, a green light transmissive region, and a blue light transmissive region. The fluorescent powder on the transmissive fluorescent wheel may be green fluorescent powder or red fluorescent powder. Thus, the fluorescence beam may be green fluorescence or red fluorescence. Thus, the three-primary-color laser beams and the fluorescence beam are combined into an illuminating light beam.

It can be understood that the above described three laser device sets may alternatively generate outputs. When alternatively generating the outputs, the laser beam and the fluorescence beam with the same color may be simultaneously outputted. When the light source light beam is combined with the fluorescence beam into the illuminating light beam, the light can be mixed. Light mixed effect can expand the scope of the color gamut, increase brightness, correct color coordinates for such color, and reduce speckle effect of the laser.

In some embodiments of this application, the second laser source 14 and the third laser source 15 both serve as an excitation light source. In this implementation, the first laser source 13 may serve as the primary color light source. The second light beam and the third light beam are incident on the reflecting surface 111 of the light focusing cup 11, and reflected by the reflecting surface 111 of the light focusing cup 11 onto the incident point on the transmissive fluorescent wheel, exciting the fluorescent powder of the transmissive fluorescent wheel to produce a fluorescence beam.

When the first laser source 13, the second laser source 14 and the third laser source 15 are all laser devices, the second laser source 14 and the third laser source 15 may be blue laser devices or UV laser devices. Thus, the fluorescent powder on the transmissive fluorescent wheel may be green fluorescent powder, or green and yellow fluorescent powder.

When the second laser source 14 and the third laser source 15 are both blue laser devices, the fluorescent region may be provided with green fluorescent powder, and the transmissive region may be partitioned into a blue light transmissive region and a red light transmissive region. In this implementation, the first laser source 13 may be a red laser device. Now, the excitation light beam emitted from the excitation light source excites the green fluorescent powder to produce a green fluorescence beam. The green fluorescence beam, the blue laser beam and the red laser beam may form three-primary-color light beams that are combined into an illuminating light beam. If the fluorescent region includes green fluorescent powder and yellow fluorescent powder, the excitation light beam can excite the fluorescent powder to produce a green fluorescence beam and a yellow fluorescence beam. Now, the first laser source 13 may be any one of a blue laser device, a red laser device and a green laser device. Thus, the yellow fluorescence beam, the green fluorescence beam and the blue laser beam form four-primary-color light beams, which are combined into a white illuminating light beam.

In some embodiments of this application, the first laser source 13, the second laser source 14 and the third laser source 15 all serve as excitation light sources. When the first laser source 13, the second laser source 14 and the third laser source 15 are all laser devices, the first laser source 13, the second laser source 14 and the third laser source 15 may all be blue laser devices. The fluorescent region may include green fluorescent powder and yellow fluorescent powder. Now, the yellow fluorescence beam, the green fluorescence beam and the blue laser beam form four-primary-color light beams, which are combined into a white illuminating light beam.

In some embodiments of this application, the third laser source in the laser source 01 may be omitted. The laser source 01 may include only the first laser source 13 and the second laser source 14. At least one of the first light beam and the second light beam can excite the fluorescent powder to produce a fluorescence beam, and form an illuminating light beam on the rear side of the transmissive fluorescent wheel. The above described laser source 01 may also serve as excitation for producing a fluorescence beam that can be combined with the first light beam and/or the second light beam into an illuminating light beam.

When the first laser source 13 or the second laser source 14 serves as the excitation light source, the excitation light source may be a blue laser device. In this implementation, the fluorescent region may include fluorescent powder of a single color or two colors. Now, the first light beam, the second light beam and the fluorescence beam can again form three-primary-color light beams that are combined into a white illuminating light beam.

When the first laser source 13 and the second laser source 14 both serve as the excitation light source at the same time, the fluorescent region may include yellow fluorescent powder and green fluorescent powder. Now, the first laser source 13 and the second laser source 14 may both be blue laser devices, and the first light beam and the second light beam both irradiate on the fluorescent powder. The blue excitation light beam excites the yellow fluorescent powder and the green fluorescent powder to produce a yellow fluorescence beam and a green fluorescence beam. The yellow fluorescence beam may pass through a red optical filter to obtain a red fluorescence beam. Now, the blue laser beam, the green fluorescence beam and the red fluorescence beam form three-primary-color light beams, which can also be combined into a white illuminating light beam.

The provided laser source can converge laser beams from the first laser source, the second light source and the third light source on the surface of the transmissive fluorescent wheel using the light focusing cup. The second light source, the third light source and the transmissive fluorescent wheel are disposed inside the light focusing cup, making effective use of the inner space of the light focusing cup. In addition, light beams from multiple light source sets are converged by the light focusing cup together, and can be combined with the fluorescence beam through the fluorescent wheel component, thereby reducing the number of light combining elements employed in the optical circuit. As a result, the aforementioned laser source is compactly configured, with reduced framework volume, which facilitates microminiaturization of laser projection devices.

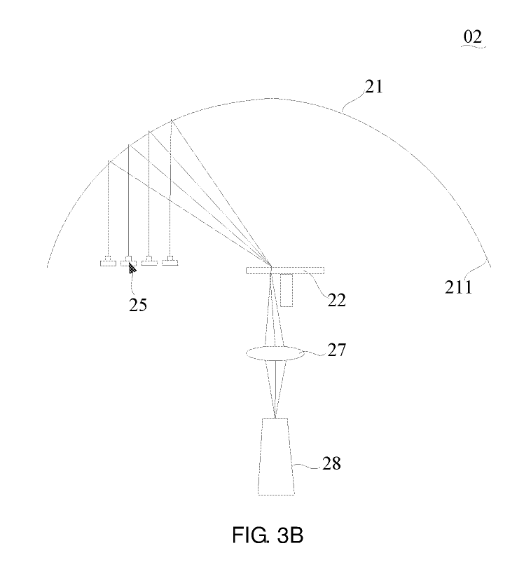

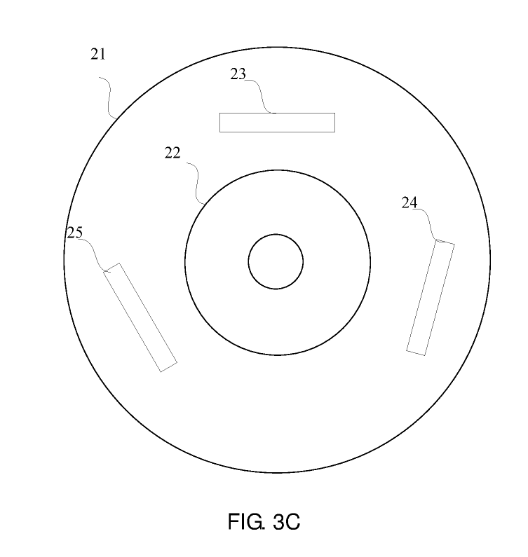

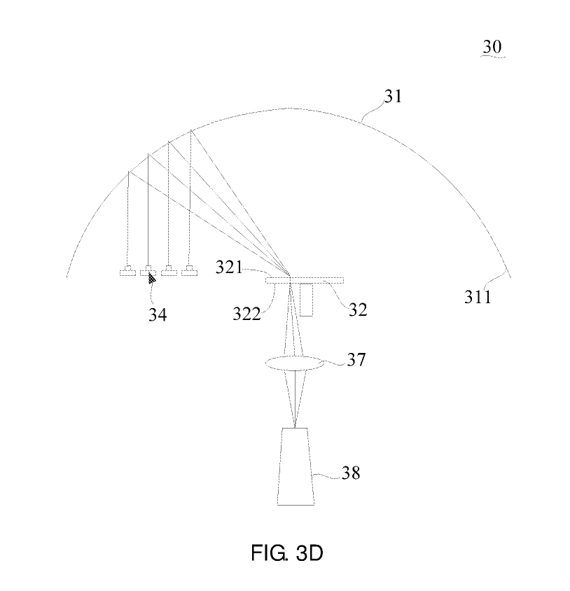

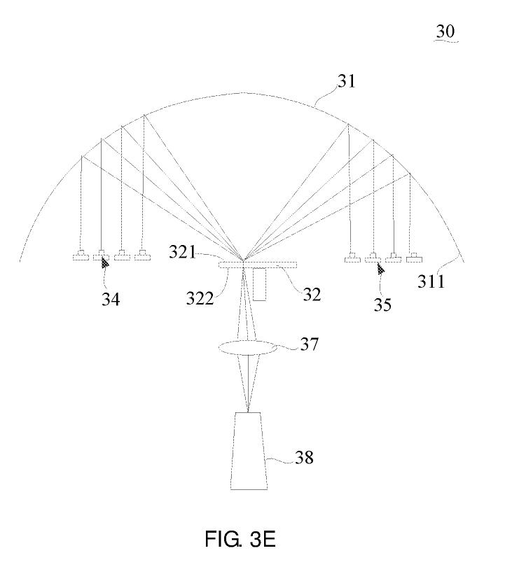

Some embodiments of this application further provide a laser source. As depicted in FIG. 3A, a laser source 02 includes: a light focusing cup 21, a light transmissive processing assembly 22, and a light source, where the light transmissive processing assembly 22 and the light source are both disposed on the inner side of the light focusing cup 21, i.e. the light transmissive processing assembly 22 and the light source are both located on the side of a reflecting surface of the light focusing cup 21, and the light source is used for emitting an excitation light beam. The excitation light beam is reflected by the reflecting surface of the light focusing cup 21 onto the light transmissive processing assembly 22. An incident point on the light transmissive processing assembly 12 may be provided at the focal point of the reflecting surface of the light focusing cup 11, where the incident point on the light transmissive processing assembly 12 means a location on the light transmissive processing assembly for receiving incident light, and the light transmissive processing assembly also can perform light beam diffusion, phase change or fluorescence excitation while allowing the light to pass through.

The above described light transmissive processing assembly 22 may be a transmissive diffusing sheet which is disposed with a diffuser on a surface thereof facing the reflecting surface of the light focusing cup 21 and which is transmissive to a light beam. The excitation light beam is reflected onto the diffusing sheet, passes through the diffusing sheet, and emerges. FIG. 3A shows a schematic diagram of a laser source in which the light transmissive processing assembly 22 is a transmissive diffusing sheet.

As depicted in FIGS. 3A, 3B and 3C, when the aforementioned light transmissive processing assembly 22 is a transmissive diffusing sheet, the light source may include a first laser source 23, a second laser source 24 and a third laser source 25, where the second laser source 24 and the third laser source 25 may be disposed around the diffusing sheet. FIGS. 3A, 3B and 3C are used to depict, by way of example, the laser sources observable from various angles. Those skilled in the art can understand that FIGS. 3A-3C are merely used for explaining that multiple laser sources are disposed around the diffusing sheet, but not limiting the relative positions, e.g. degree of included angles and height, between the laser sources, which may be selected according to specific needs.

Content of the above described embodiments may be referred to for the color setting of the light beams emitted from the first laser source 23, the second laser source 24 and the third laser source 25, as well as the mode in which the illuminating light beam is transmitted, which will not be repeated herein.

In this example, a paraboloid cup may be selected as the light focusing cup 21 as in the above embodiments. Thus, the first laser source 23, the second laser source 24 and the third laser source 25 emits parallel light beams that are parallel with the central axis of the paraboloid, respectively, which are converged at the focal point of the paraboloid after being reflected by the concaved reflecting surface 211 of the paraboloid cup, the focal point being located on a light-incoming surface of the diffusing sheet.

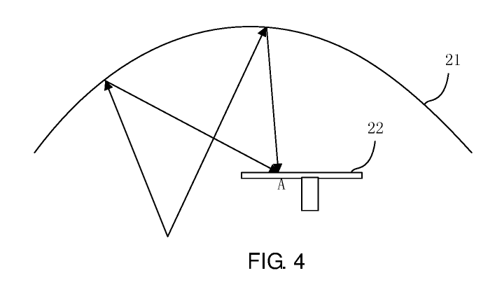

Alternatively, the concaved surface of the light focusing cup 21 is a sphere on which a high reflection film is disposed. Yet in some applications, the focal point of the sphere is located on the light-incoming surface of the diffusing sheet. As depicted in FIG. 4, the spherical light focusing cup 21 has a spherical focal point A.

The configuration may be that: two laser sources of the first laser source, the second laser source and the third laser source are symmetrically disposed on two sides of the diffusing sheet about the spherical focal point, while another laser source is disposed at any angle that allows light from the three light sources to converge at a single point after being reflected by the reflecting surface 211, and hence the diffusing sheet is located at the point of intersection of the three light beams.

Alternatively, the three laser sources are arranged surrounding along the periphery of the diffusing sheet.

Since the concaved reflecting surface of the light focusing cup 21 is a sphere, one or two of the three laser sources may be disposed to form a certain angle with the plane where the diffusing sheet is located. Now, light beams from such two laser sources form a certain angle with respect to the symmetry axis of the concaved reflecting surface, instead of being mutually parallel light beams as described in the above embodiments. Since the concaved reflecting surface is a sphere, the light beam incident on the sphere is reflected and converged along the radial direction of the sphere to focus at the focal point of the sphere.

The above described diffusing sheet may vibrate, swing or rotate, and has different diffusing region partitions. Now, descriptions will be made by taking a diffusing sheet that vibrates as an example. Thus, a schematic structural plan of a diffusing sheet may be as illustrated in FIG. 6B. The diffusing sheet may be provided with a first diffusing region a and a second diffusing region b. When the diffusing sheet vibrates up-and-down, a light beam falls on the first diffusing region a at a first moment, and a light beam falls on the second diffusing region b at a second moment. The colors of the light beams incident on these two diffusing regions will not be specified, and may be determined according to the lighting time sequence of the light sources.

For the purpose of improving speckle removing effect, the above diffusing regions may be configured with different divergency angles, so as to increase the diversity in the divergency angle that the light beams are diffused.

Alternatively, on the basis of the above described diffusing region partitions, the light-outgoing surface of the diffusing sheet may also be provided with micro-structures that are similar to diffusing particles on the light-incoming surface of the diffusing sheet. However, the divergency angle may be different for the diffusing micro-structures on the light-incoming surface and the light-outgoing surface, or the granularity may be different for the diffusing particles. Thus, a single diffusing sheet can be utilized to diverge the light beam passing through the light-incoming surface and the light-outgoing surface by different degrees, which also helps improving efficiency of the diffusing sheet in speckle removing.

Although only two diffusing regions are provided in the above example depicted in FIG. 6B, a third diffusing region can certainly be disposed in addition, and according to the vibration frequency and light source lighting time sequence, lasers of different colors can enter different diffusing regions.

A light beam transferring process of a laser source framework will be described using an example in which the first laser source 23 emits a blue laser, the second laser source 24 emits a red laser, and the third laser source 25 emits a green laser.

At a first moment when the first laser source 23 is lighted and emits the blue laser, the other two laser sources stays unlighted. The blue laser passes through an optical through-hole on the light focusing cup 21, and falls on the first diffusing region of the diffusing sheet.

At a second moment when the second laser source 24 is lighted and emits the red laser, the first laser source 23 and the third laser source 25 are unlighted. The red laser beam is incident on, and reflected by, the concaved reflecting surface of the light focusing cup, and is converged on the second diffusing region of the diffusing sheet. Here, the divergency angle is larger for the second diffusing region than for the first diffusing region.

At a third moment when the third laser source 25 is lighted and emits the green laser, the blue laser and red laser are not outputted similarly. The green laser beam is incident on, and reflected by, the concaved reflecting surface of the light focusing cup, and is converged on the third diffusing region of the diffusing sheet. Here, the third diffusing region may has a divergency angle that is identical to divergency angels for the first diffusing region and second diffusing region, or that is different from both.

Similar to content in the aforementioned embodiments, the laser source 02 may further be provided with a collimating lens and a converging lens 27 along the direction in which the illuminating light beam propagates. The collimating lens collimates an illuminating light beam. The converging lens 37 converges and focuses the illuminating light beam. After being transmitted through the diffusing sheet, the illuminating light beam will approximate Lambertian body distribution and need to be collimated by the collimating lens and converged by the converging lens 27.

The laser source 02 may further be provided with a light uniforming member 28 along the direction in which the illuminating light beam propagates. An incident point on the light uniforming member 28 is provided at the focal point of the converging lens 27, and the incident point on the light uniforming member 18 is the central point of an end surface of the light uniforming member 28, the end surface being on an end thereof closer to the diffusing sheet. The light uniforming member 28 is used for uniforming the illuminating light beam. The illuminating light beam is converged at the incident point on the light uniforming member 18 through the converging lens 17, and enters into the light uniforming member 28, where the light beam is uniformized by the light uniforming member 28. The light uniforming member 28 may be an optical wand. By means of being converged through the collimating lens and the converging lens 37 disposed on the rear side of the diffusing sheet and entering into the light uniforming member 38, a uniform illuminating light beam is provided.

With the light focusing cup 21 in the provided laser source 02, laser beams from the first laser source 23, the second laser source 24 and the third laser source 25 are, after being reflected, converged on a surface of the diffusing sheet. In addition, following a lighting time sequence, different laser beams pass through, and are diffused by, different diffusing regions on the diffusing sheet, accomplishing speckle removing purposes, while balancing speckle removing effect for lasers of different colors. Moreover, by disposing the three laser sources and the diffusing sheet inside the light focusing cup, the inner space of the light focusing cup is effectively utilized. The above laser source 02 includes a speckle removing component with improved utilization, and has a compact structure, which facilitates microminiaturization of laser projection devices.

It should be noted that some embodiments of this application are described by taking a light focusing cup provided with three laser device sets of different colors on its inner side as an example. Of course, it is also possible to dispose, according to product requirements and utilizing the above described conceptual ideas, two laser device sets of different colors which undergo speckle removing, while another light source of another color may be, for instance, an LED light source or a fluorescence source, instead of a laser device. The lasers of the two colors may, following speckle removing by the diffusing sheet, be combined with the light source of the third color and form the light source framework. A dual color laser source, in which the above light source framework is employed, can also realize speckle removing through a single diffusing sheet, while achieving the goal of compacting the light source framework.

Some embodiments of this application further provide a laser source in which a light transmissive processing assembly is a transmissive fluorescent wheel. As depicted in FIG. 3D, the laser source 30 includes a light focusing cup 31, a transmissive fluorescent wheel 32, and a light source.

The light focusing cup 31 is provided with a concaved reflecting surface 311 on the inner side thereof.

The transmissive fluorescent wheel 32 is disposed on the inner side of the light focusing cup. The surface of one side of the transmissive fluorescent wheel 32 facing the reflecting surface is referred to as the front side 321, while the surface of the other side is referred to as the rear side 322. The transmissive fluorescent wheel is provided with a fluorescent region for producing fluorescence and a transmissive region on the front side 321 thereof.

The light source is disposed on a side of the light focusing cup 31 that is closer to the reflecting surface 311. The light source is disposed in parallel with the transmissive fluorescent wheel 32, and may include an excitation light source 34. The excitation light source 34 emits an excitation light beam, and the excitation light beam is reflected by the reflecting surface of the light focusing cup 31 onto fluorescent powder on the transmissive fluorescent wheel 32. The transmissive fluorescent wheel 32 is excited to produce a fluorescence beam that passes through the transmissive fluorescent wheel and emerges, forming an illuminating light beam on the rear side 322 of the transmissive fluorescent wheel 32.

The excitation light source 34 emits an excitation light beam from the inner side of the light focusing cup 31, and the excitation light beam excites the fluorescent powder to produce a fluorescence beam. The transmissive fluorescent wheel can transmit the excitation light beam through, and then the excitation light beam is combined with the fluorescence beam, which can form a white illuminating light beam as well.

When the light source is a single color laser source, the fluorescence beam may include multiple primary colors.

For instance, when the light source is a blue laser device, the fluorescent powder may include yellow fluorescent powder and green fluorescent powder. The excitation light beam irradiates on the fluorescent powder, and the blue excitation light beam excites the yellow fluorescent powder and the green fluorescent powder to produce a yellow fluorescence beam and a green fluorescence beam. A yellow fluorescence beam may pass through a red optical filter to obtain a red fluorescence beam. Thus, the blue laser beam, the green fluorescence beam and the red fluorescence beam form three-primary-color light beams, which can also be combined into a white illuminating light beam.

It can be understood that the excitation light source 34 may be a laser device array formed by arranging multiple laser devices, or an LED array formed by arranging multiple LEDs. In addition, there may be multiple sets of laser device arrays or LED arrays. Such multiple sets of laser device arrays or LED arrays may be distributed symmetrically about the transmissive fluorescent wheel, or asymmetrically around the transmissive fluorescent wheel according to different light intensity distribution.

It can be understood that the light source may be a dual color laser source. The fluorescence beam includes at least one primary color. For instance, when the light source includes a blue laser device and a red laser device, the fluorescence beam may be a green fluorescence beam and/or a yellow fluorescence beam. The green fluorescence beam and/or the yellow fluorescence beam, together with the blue laser beam and the red laser beam, form light beams of at least three primary colors, which are combined into a white illuminating light beam.

It can be understood that the light source may be a three color laser source. The fluorescence beam includes at least one primary color. For instance, the light source includes a blue laser device, a red laser device, and a green laser device. The fluorescence beam may be a green fluorescence beam and/or a yellow fluorescence beam. The green fluorescence beam and/or the yellow fluorescence beam, together with the blue laser beam and the red laser beam, form light beams of at least three primary colors, which are combined into a white illuminating light beam.

Referring to FIG. 3E, in some embodiments of this application, the light source may further include a primary color light source 35 that is used for providing a primary color light beam of at least one color. The primary color light source 35 and the excitation light source 34 are disposed around the peripheral of the transmissive fluorescent wheel 32. In addition, the primary color light source 35 emits a primary color light beam that is reflected by the reflecting surface 311 onto, and passes through, the transmissive fluorescent wheel 32. The excitation light beam, the primary color light beam and the fluorescence beam form three-primary-color light beams that are combined into a white illuminating light beam.

The excitation light source 34 and the primary color light source 35 may be a laser device array or LED array.

The concaved surface of the light focusing cup 31 is a paraboloid. An incident point on the transmissive fluorescent wheel 32 may be provided at the focal point of the paraboloid. For instance, the laser device array or LED array emits parallel light beams. Thus, the excitation light beam and the primary color light beam are both parallel light beams that are parallel to the central axis of the paraboloid. Therefore, when the excitation light beam and the primary color light beam fall in parallel on the reflecting surface 311 of the light focusing cup 31, both light beams will converge at the focal point of the paraboloid after being reflected by the reflecting surface 311. Since no other converging lens set is required to converge the excitation light beam and the primary color light beam at the same point, structure of the laser source 30 can be simplified, and volume of the laser source 30 can be reduced.

The laser source 30 may further be provided with a collimating lens and a converging lens 37 along the direction in which the illuminating light beam propagates. The collimating lens collimates the illuminating light beam. The converging lens 37 converges and focuses the illuminating light beam. After passing through the transmissive fluorescent wheel 32, the illuminating light beam will approximate Lambertian body distribution and need to be collimated by the collimating lens and converged by the converging lens 37.

It can be understood that the collimating lens may also be a collimating lens set, which will not be limited herein. Similarly, the converging lens 37 may be a converging lens set consisting of multiple lenses, which will not be limited herein, as long as the illuminating light beam can be converged.

The laser source 30 may further be provided with a light uniforming member 38 along the direction in which the illuminating light beam propagates. An incident point on the light uniforming member 38 is provided at the focal point of the converging lens 37, and the incident point on the light uniforming member 38 is the central point of an end surface which is on an end of the light uniforming member 38 and is closer to the transmissive fluorescent wheel 32. The light uniforming member 38 is used for uniforming the illuminating light beam. The illuminating light beam is converged at the incident point on the light uniforming member 38 through the converging lens 37, and enters into the light uniforming member 38, where the light beam is uniformized by the light uniforming member 38. The light uniforming member 38 may be an optical wand. By means of being converged through the collimating lens and the converging lens 37 disposed on the rear side 322 of the transmissive fluorescent wheel 32 and entering into the light uniforming member 38, a uniform illuminating light beam is provided.

In the above described laser source 30, the light focusing cup 31 can converge all light beams from the light source 33 on the front side 321 of the transmissive fluorescent wheel 32. The light source 33 and the transmissive fluorescent wheel 32 are disposed inside the light focusing cup 31, making effective use of the inner space of the light focusing cup 31. Moreover, the use of multiple converging lens sets and reflecting mirror sets is avoided, simplifying the structure of the laser source 30. As a result, the aforementioned laser source 30 is compactly configured, with reduced framework volume, which facilitates microminiaturization of laser projection devices.

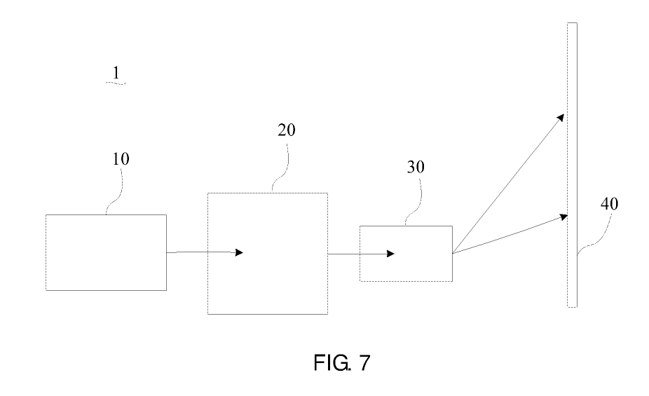

As depicted in FIG. 7, some embodiments of this application further provide a laser projection device 1 that may be an ultra short throw projection device. The laser projection device 1 includes a laser source 10, an optical assembly 20, a lens 30, and a projection screen 40, where the lens 30 may be an ultra short throw projection lens.

The laser source 10 includes: a light focusing cup, provided with a concaved reflecting surface on the inner side thereof and an optical through-hole on the bottom thereof; where:

a light transmissive processing assembly is disposed on the inner side of the light focusing cup and opposite to the optical through-hole;

a first laser source is configured to emit a first light beam and disposed on the outer side of the light focusing cup, the first light beam being incident on the light transmissive processing assembly through the optical through-hole;

a second laser source is configured to emit a second light beam and disposed on the inner side of the light focusing cup, the second light beam being incident on the light transmissive processing assembly after being reflected by the reflecting surface of the light focusing cup; and

the laser source outputs three-primary-color light to the optical assembly which adjusts amount of the three-primary-color light, and the adjusted three-primary-color light is outputted to the lens and projected through the lens onto the projection screen to form a projected image.

The light transmissive processing assembly may be a transmissive diffusing sheet, or a transmissive fluorescent wheel.

The laser source 10 may further include: a third laser source, configured to emit a third light beam and disposed in parallel with the light transmissive processing assembly, the third light beam being incident on the light transmissive processing assembly after being reflected by the reflecting surface of the light focusing cup.

In the laser projection device 1, the laser source 10 outputs in time sequence three-primary-color light that enters the optical assembly 20 through a light uniforming component. The optical assembly 20 includes an optical wand structure, an optical path transition device, and a digital micromirror device (DMD) chip. The DMD chip includes multiple micro reflecting mirrors that, when driven by current, rotates within a certain angle range to adjust the amount of light entering into the lens 30, thereby causing various colors to appear on an image. After being adjusted by the DMD chip and reaching the lens 30, the light undergoes multiple times of refraction and reflection via optical lenses in the lens 30, and is ultimately projected onto the projection screen 40, forming the projected image.

By applying the laser source in the above embodiments, the light source framework can be compacted, which is advantageous in miniaturization of laser projection devices.

Although the present application has been described with reference to several typical embodiments, it should be understood that, the terms used are illustrative and exemplary, rather than limiting. Since the present application can be implemented in various forms without departing from the spirit or essence herein, the above described embodiments shall not be limited by any of the above described details, but be broadly construed within the spirit and scope defined by the accompanying claims. Therefore, any and all changes and modifications that fall under the claims or equivalent scopes thereof shall be deemed to be covered under the accompanying claims.

What is claimed is:

1. A laser source, comprising:
a light focusing cup, provided with a concaved reflecting surface on an inner side thereof and an optical through-hole on a bottom thereof;
a light transmissive processing assembly, disposed on the inner side of the light focusing cup and opposite to the optical through-hole;
a first laser source, configured to emit a first light beam and disposed on an outer side of the light focusing cup, the first light beam being incident on the light transmissive processing assembly through the optical through-hole; and
a second laser source, configured to emit a second light beam and disposed on the inner side of the light focusing cup, the second light beam being incident on the light transmissive processing assembly after being reflected by the reflecting surface of the light focusing cup.

2. The laser source according to claim 1, wherein the light transmissive processing assembly is a transmissive diffusing sheet;
the transmissive diffusing sheet is provided with a diffuser on a surface thereof; and
the first light beam and the second light beam are transmitted through the diffusing sheet.

3. The laser source according to claim 2, wherein the diffusing sheet is capable of rotating, or vibrating, or swinging.

4. The laser source according to claim 1, wherein the reflecting surface of the light focusing cup is a paraboloid; a light beam incident on the reflecting surface is a parallel light beam that is parallel to a central axis of the paraboloid; and an incident point on the light transmissive processing assembly is provided at a focal point of the paraboloid.

5. The laser source according to claim 1, wherein the reflecting surface of the light focusing cup is a sphere; and an incident point on the light transmissive processing assembly is provided at a focal point of the sphere.

6. The laser source according to claim 2, wherein the diffusing sheet comprises a first diffusing region and a second diffusing region, the first laser source and the second laser source are lighted according to a time sequence, and sequentially incident on the first diffusing region and the second diffusing region.

7. The laser source according to claim 2, further comprising: a third laser source, configured to emit a third light beam and disposed in parallel with the diffusing sheet, the third light beam being reflected by the reflecting surface of the light focusing cup and incident on the diffusing sheet.

8. The laser source according to claim 7, wherein the first light beam has a color of blue; the second light beam has a color of red; and the third light beam has a color of green.

9. The laser source according to claim 1, wherein the light transmissive processing assembly is a transmissive fluorescent wheel; the transmissive fluorescent wheel is partitioned into a fluorescent region provided with fluorescent powder and a transmissive region;
the first light beam and the second light beam are incident on the transmissive fluorescent wheel, the fluorescent powder produces a fluorescence beam under excitation by at least one of the first laser source and the second laser source, and at least one of the first light beam and the second light beam is transmitted through the transmissive region;
wherein the light beam transmitted through the transmissive region and the fluorescence beam transmitted through the transmissive fluorescent wheel form an illuminating beam.

10. The laser source according to claim 9, wherein the first laser source is an excitation light source, the second laser source is a primary color light source, and the first light beam is incident on the fluorescent powder of the transmissive fluorescent wheel and excites the fluorescent powder to produce the fluorescence beam.

11. The laser source according to claim 9, wherein the first laser source is a primary color light source, the second laser source is an excitation light source, and the second light beam is incident on the reflecting surface of the light focusing cup and reflected onto the transmissive fluorescent wheel, and excites the fluorescent powder of the transmissive fluorescent wheel to produce the fluorescence beam.

12. The laser source according to claim 9, wherein the first laser source and the second laser source are both excitation light sources, and the first light beam and the second light beam excite the fluorescent powder of the transmissive fluorescent wheel to produce the fluorescence beam.

13. The laser source according to claim 9, further comprising: a third laser source, configured to emit a third light beam and disposed in parallel with the transmissive fluorescent wheel, the third light beam being reflected by the reflecting surface of the light focusing cup and incident on the transmissive fluorescent wheel.

14. A laser source, comprising:
a light focusing cup, provided with a concaved reflecting surface on an inner side thereof;
a light transmissive processing assembly, disposed on the inner side of the light focusing cup; and
a light source, disposed on the inner side of the light focusing cup and configured to emit an excitation light beam, wherein the excitation light beam is reflected onto the light transmissive processing assembly by the reflecting surface of the light focusing cup.

15. The laser source according to claim 14, wherein the light transmissive processing assembly is a transmissive diffusing sheet, the diffusing sheet is provided with a diffuser on a surface thereof facing the reflecting surface and is transmissive to a light beam; and
the excitation light beam is reflected onto the diffusing sheet, passes through the diffusing sheet, and emerges.

16. The laser source according to claim 15, wherein the light source comprises a blue laser source and a red laser source.

17. The laser source according to claim 14, wherein the light transmissive processing assembly is a transmissive fluorescent wheel, the transmissive fluorescent wheel is partitioned into a fluorescent region provided with fluorescent powder and a transmissive region;
the light source is disposed in parallel with the transmissive fluorescent wheel, the excitation light beam is reflected onto the fluorescent region of the transmissive fluorescent wheel and excites the fluorescent powder to produce a fluorescence beam and transmit the fluorescence beam; and
the light beam transmitted through the transmissive region and the fluorescence beam transmitted through the transmissive fluorescent wheel form an illuminating light beam.

18. A laser projection device, comprising: a laser source, an optical assembly, a lens, and a projection screen; the laser source comprising: a light focusing cup, provided with a concaved reflecting surface on an inner side thereof and an optical through-hole on a bottom thereof; wherein,
a light transmissive processing assembly is disposed on the inner side of the light focusing cup and opposite to the optical through-hole;
a first laser source is configured to emit a first light beam and disposed on an outer side of the light focusing cup, the first light beam being incident on the light transmissive processing assembly through the optical through-hole;
a second laser source is configured to emit a second light beam and disposed on the inner side of the light focusing cup, the second light beam being incident on the light transmissive processing assembly after being reflected by the reflecting surface of the light focusing cup; and
the laser source outputs three-primary-color light to the optical assembly, the optical assembly adjusts amount of the three-primary-color light, and the adjusted three-primary-color light is outputted to the lens and projected through the lens onto the projection screen to form a projected image.

19. The laser projection device according to claim 18, wherein:
the light transmissive processing assembly is a transmissive diffusing sheet or a transmissive fluorescent wheel.

20. The laser projection device according to claim 18, further comprising:
a third laser source, configured to emit a third light beam and disposed in parallel with the light transmissive processing assembly, the third light beam being reflected by the reflecting surface of the light focusing cup and incident on the light transmissive processing assembly.
